(19) United States
(12) Patent Application Publication
(10) Pub. No.: US 2015/0072103 A1
(43) Pub. Date: Mar. 12, 2015

(54) LINKED ARRAYS OF VOID CELLS

(71) Applicant: Skydex Technologies, Inc., Centennial, CO (US)

(72) Inventors: Rico Tresso, Castle Rock, CO (US); Ethan Wyman, Lakewood, CO (US); Collin Metzer, Highlands Ranch, CO (US); Peter M. Foley, Castle Rock, CO (US); Eric DiFelice, Parker, CO (US)

(21) Appl. No.: 14/483,529

(22) Filed: Sep. 11, 2014

Related U.S. Application Data
(60) Provisional application No. 61/876,648, filed on Sep. 11, 2013.

(51) Int. Cl. B32B 3/12; B32B 7/12; B32B 7/08; B29C 65/48; B32B 27/08

(52) U.S. Cl. CPC B32B 3/12; B29C 65/48; B32B 27/08; B32B 7/08; B32B 7/12; B32B 2250/02; B32B 2250/03; B32B 2305/024; B32B 2307/56
USPC 428/116; 156/93

(57) ABSTRACT

Implementations described and claimed herein include methods of manufacturing related to a spaced array of individually formed void cells, which are linked together. The void cells are protruding, resiliently compressible cells manufactured by thermoforming, extrusion, injection molding, laminating, and/or blow molding processes. The individual void cells are molded and arranged in an array. A separate, porous binding layer is attached to the individual void cells in the array. In one implementation, two arrays may each comprise of linked individually formed void cells, wherein each array is aligned with the other array, and linked individually formed void cells of one array are positioned opposite the linked individually formed void cells of the other array, sharing the same binding layer. In another implementation, multiple arrays can be stacked upon one another. In another implementation, the linked individually formed void cells have substantially different force-deflection characteristics.

### CROSS REFERENCE TO RELATED APPLICATIONS

The present application claims priority to pending U.S. Provisional Patent Application Ser. No. 61/876,648, entitled “Linked Arrays of Void Cells,” filed on Sep. 11, 2013, all of which is specifically incorporated by reference for all it discloses and teaches.

### BACKGROUND

Sheets of protruding resiliently compressible void cells are used in cushioning, impact protection, vibration dampening, and/or other applications. For example, a cushioning system may be placed adjacent to a portion of the body to provide a barrier between the body and one or more objects that would otherwise impinge on the body producing a negative effect such as a pressure concentration, an impact force, or a vibration. A pocketed spring mattress contains an array of cells or springs that cushion the body from a bed frame, reducing pressure concentrations. Similarly, chairs, gloves, knee-pads, helmets, etc. may include a cushioning system that provides a barrier between a portion of the body and one or more objects.

### SUMMARY

Implementations described and claimed herein include methods of manufacturing related to a spaced array of individually formed void cells, which are linked together. The void cells are protruding, resiliently compressible cells manufactured by thermoforming, extrusion, injection molding, laminating, and/or blow molding processes. The individual void cells are molded and arranged in an array. A separate, porous binding layer is attached to the individual void cells in the array. In one implementation, two arrays may comprised of linked individually formed void cells, wherein each array is aligned with the other array, the linked individually formed void cells of one array are positioned opposite the linked individually formed void cells of the other array, sharing the same binding layer. In another implementation, multiple arrays can be stacked upon one another. In another implementation, the linked individually formed void cells have substantially different force-deflection characteristics.

This Summary is provided to introduce an election of concepts in a simplified form that are further described below in the Detailed Description. This Summary is not intended to identify key features or essential features of the claimed subject matter, nor is it intended to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

### BRIEF DESCRIPTIONS OF THE DRAWINGS

FIG. 1 illustrates a top plan view of an example linked array of individual void cells.

FIG. 2 illustrates a bottom perspective view of an example linked array of individual void cells.

FIG. 3 illustrates a top perspective view of an example linked system of individual opposing void cells.

FIG. 4 illustrates a side perspective view of an example linked system of individual opposing void cells.

FIG. 5 illustrates a bottom plan view of an example linked array of individual void cells having varying force-deflection characteristics.

FIG. 6 illustrates a bottom perspective view of an example linked array of individual void cells.

FIG. 7 illustrates example operations for manufacturing a linked array of void cells.

### DETAILED DESCRIPTIONS

Sheets of protruding resiliently compressible void cells are typically manufactured by forming the void cells in a planar sheet using thermoforming and/or blow molding processes. The cells are directly coupled together or one or more unifying layers are used to couple each of the cells together at their extremities. However, there are limitations to the resulting geometry when using thermoforming and/or blow molding processes to form the sheet of protruding void cells.

For example, each of the individual void cells and the layer binding the void cells together are inherently made of the same material because they are formed from the same sheet of base material. Because thermoforming and/or blow molding processes stretch the base material to form the sheets of void cells, the thickness of the void cell walls inherently vary, becoming thinner away from the binding layer. Further, the spacing between the individual void cells in the sheet of protruding void cells is limited to a minimum value defined by the manufacturing process used to form the sheet of protruding void cells.

Additionally, while directly coupling the cells together or indirectly coupling the extremities of the cells together is effective in tying the cushioning system together, the independence of each of the cells is reduced. This lack of independence can lead to an increased load being placed on a small area of the body (referred to herein as a point load). A point load deforming one of the cells is likely to deform adjacent cells directly or by stressing the unifying layer(s). As a result, the resistance to deflection at the point of contact increases due to the deflection of multiple cells or springs. The increased resistance to deflection may cause pressure points on portions of a user's body that protrude into the cushioning system more than other portions of the user's body (e.g., at a user's shoulders and hips on a mattress).

The disclosed technology includes methods of manufacturing related to a spaced array of individually formed void cells, which are linked together. The void cells are protruding, resiliently compressible cells manufactured by thermoforming, extrusion, injection molding, laminating, and/or blow molding processes. The individual void cells are molded and arranged in an array. A separate, porous binding layer is attached to the individual void cells in the array.

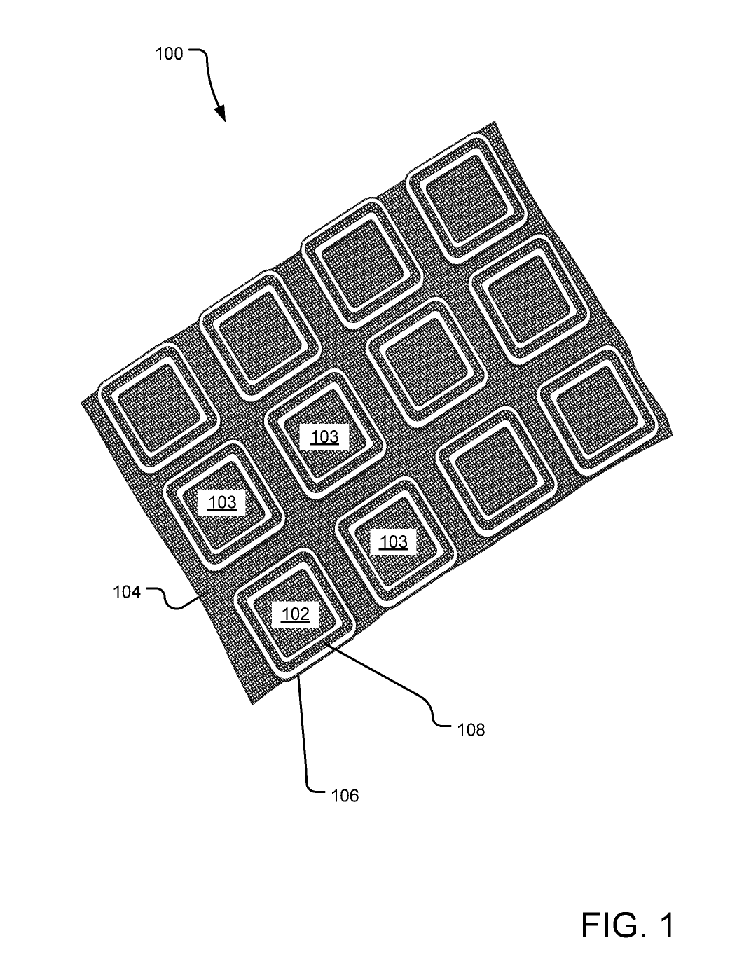

FIG. 1 illustrates a top plan view of an example linked array 100 of individually formed void cells (e.g., void cell 102). The linked array 100 is a spaced array of void cells linked together using a separate binding layer 104.

The binding layer 104 is attached to a supplemental flange (e.g., supplementary flange 108), which is attached to a void cell flange 106. The void cell flange 106 is made of the same material as the void cell and is molded with the void cells. In another implementation, there may be no supplemental flanges and the binding layer 104 may attach directly to the void cell flanges. In FIG. 1, the void cells have a square opening with a trapezoidal volume and a rounded top. In other implementations, the void cells may have other shaped openings, volumes, and tops (e.g., a round opening, with a cylindrical-shaped volume, and a square top).

As shown in FIG. 1, the binding layer 104 is a substantially planar layer used to link the void cells together. The binding layer 104 is one continuous sheet of mesh, covering the openings of the individually formed void cells. In another implementation, the binding layer may have holes that cover the openings of the void cells.

Each individually formed void cell is surrounded by neighboring void cells within the linked array 100. For example, void cell 102 is surrounded by three neighboring void cells 103. In the linked array 100, there are three neighboring void cells for each corner void cell, five neighboring void cells for each edge cell, and eight neighboring void cells for the rest of the void cells. Other implementations may have greater or fewer neighboring void cells for each void cell.

In FIG. 1, a single linked array 100 is shown. However, in other implementations, multiple linked arrays may be stacked on top of one another (e.g., two or more linked arrays 100 stacked on top of one another) to achieve intended compression/rebound characteristics of an overall system. Each array may be aligned with another array, the linked individually formed void cells are positioned opposite one another, sharing the same binding layer. In another implementation, multiple matrices, comprising arrays and shared binding layers, can be stacked upon one another. In another implementation, the linked individually formed void cells have substantially different force-deflection characteristics.

The void cell material is generally elastically deformable under expected load conditions and withstands numerous deformations without fracturing or suffering other breakdown impairing the function of the linked array 100. Example materials include thermoplastic urethane, thermoplastic elatomers, styrenic co-polymers, rubber, Dow Pellethane®, Lubrizol Estane®, Dupont™ Hytrel®, ATOFINA Pebax®, and Krayton polymers. Each of the individual void cells may be individually manufactured using a variety of techniques (e.g., blow molding, thermoforming, extrusion, injection molding, laminating, etc.).

The void cells may be unfilled or filled with ambient air, fluid, or foam. The void cells may be of a trapezoidal, cylindrical, cubical, pyramidal, hemispherical-shaped, or any other shaped volume capable of having an interior hollow volume, and round or square tops openings. The wall thickness of each of the void cells may range from 5 mil to 180 mil. Further, the wall thickness of each of the void cells may be substantially the same (or vary by no more than 10%) over the surface area of each void cell. Still further, the size of each of the void cells may range from 5 mm to 100 mm sides in a cubical implementation. Other shapes may have similar dimensions as the aforementioned cubical implementation. Still further, the void cells may be spaced a variety of distances from one another. An example spacing range is approximately 0 mm to 150 mm.

The separate binding layer 104 linking the void cells together may be a substantially planar layer used to link the individually formed void cells together. In other implementations, the binding layer has a contoured shape that corresponds to a contoured surface that the linked array 100 is placed adjacent and/or attached to. In various implementations, the binding layer 104 may be constructed with the same potential materials as the void cells (listed above) and/or different potential materials (e.g., textiles, metal screens, etc.). The binding layer 104 may have the same or a different thickness than the void cell wall thickness (e.g., 1 mil-1000 mil).

The binding layer 104 may be a solid sheet, woven mesh, or perforated sheet. For example, in mesh or perforated sheet implementations, the binding layer 104 may act to link the void cells together while allowing fluid flow through the binding layer 104 of the linked array 100. The binding layer 104 can be one continuous planar sheet, it can be discontinuous, or it can have holes, wherein the binding layer 104 links the void cells together but does not cover the openings of the void cells. In another implementation, the binding layer 104 comprises of binding strips that are positioned between and link the void cells. In an implementation where the linked array 100 is used in conjunction with additional layers in a cushioning system, the mesh or perforated binding layer 104 can substantially prevent collapse of an adjacent array into each of the individual void cells, while still permitting fluid flow through the binding layer.

In various implementations, the binding layer 104 is attached to the void cells via permanent and/or removable connections (e.g., a glued connection, a melted connection, a UV-cured connection, a RF welded connection, a laser-welded connection, another welded connection, a sewn connection, and a hook-and-loop connection). In some implementations, the binding layer 104 and opposing void cells may be pressed together to assist the attachment of the binding layer 104 between opposing void cells. In some implementations, the binding layer 104 and the void cell flanges 106 may be pressed together to assist the attachment of the binding layer 104 to the void cell flanges 106. In some implementations, the void cell flanges 106 are overlapped to tightly pack the void cells in the array 100.

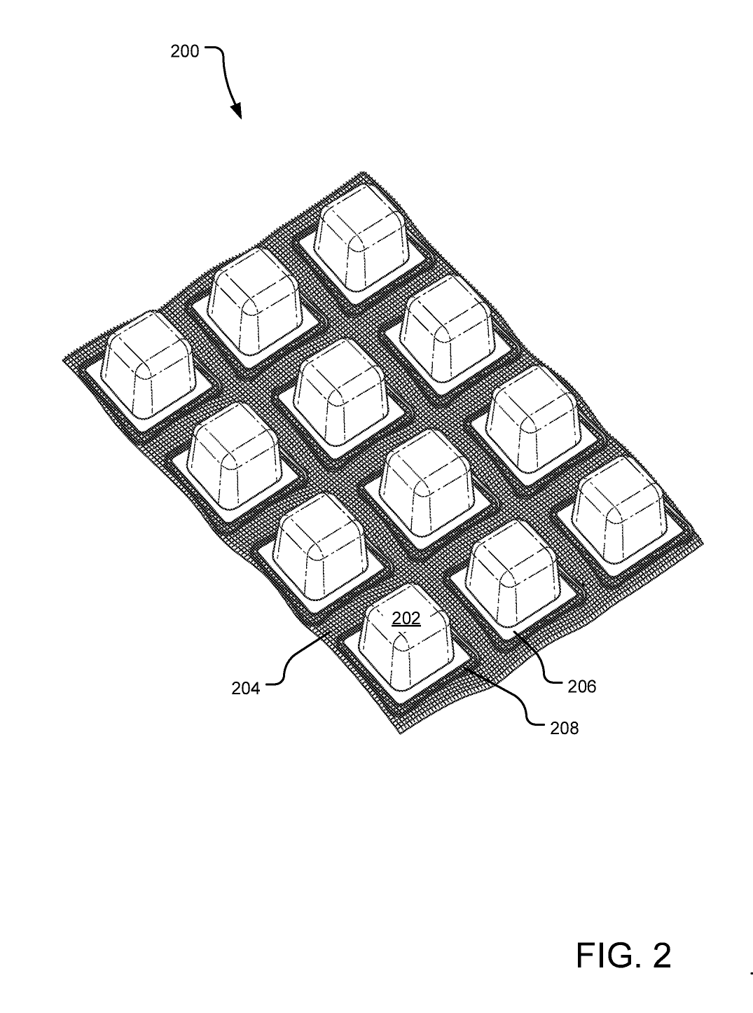

FIG. 2 illustrates a bottom perspective view of an example linked array 200 of individual void cells (e.g., void cell 202). The linked array 200 is a spaced array of void cells linked together using a separate binding layer 204.

Supplemental flanges can be used in conjunction with the flanges formed to each of the void cells. In FIG. 2, the binding layer 204 is attached to a supplemental flange (e.g., supplemental flange 208) which is attached to the void cell flange 206 of each of the void cells. The binding layer 204 may be placed between the supplemental flanges and the void cell flanges to increase the bond between the binding layer 204, the supplemental flanges, and the void cell flanges. To accomplish this arrangement, the binding layer 204 may be compressed between the supplemental flanges and the void cell flanges while a bonding technique is applied (e.g., gluing, a melting, a UV-curing, RF welding, laser-welding, other welding, and sewing) to the linked array 200. In another implementation, there are no supplemental flanges and the binding layer 204 is welded or attached directly to the void cell flange 206.

In the implementation in FIG. 2, void cells have a square opening with a trapezoidal volume and a rounded top. In other implementations, the void cells may have other shaped openings, volumes, and tops (e.g., a round opening, with a cylindrical-shaped volume, and a square top).

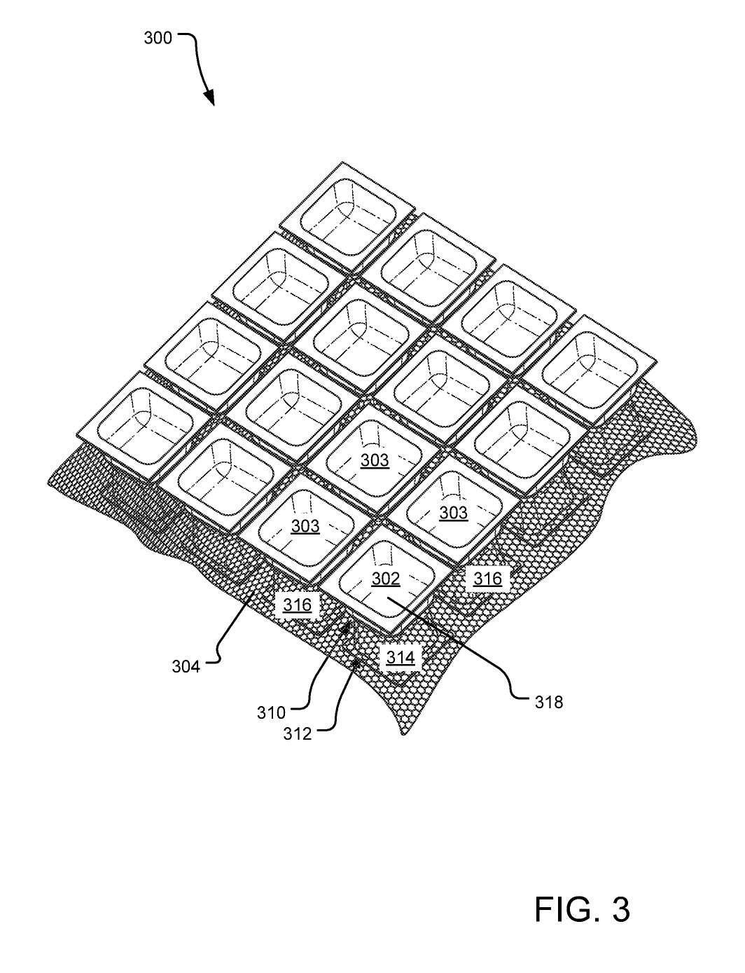

FIG. 3 illustrates a top perspective view of an example linked system 300 of individual opposing void cells (e.g., void cell 302). The void cells in the linked system 300 are arranged in a top array 310 and a bottom array 312. Each array includes an layer of void cells linked together. A common separate binding layer 304 is positioned between each array of void cells and is attached to a peak (e.g., peak 318) of each of the void cells.

The binding layer 304 in FIG. 3 is a substantially planar layer used to link the void cells together. The top array 310 is attached to a top surface of the binding layer 304 and the bottom array 312 is attached to a bottom surface of the binding layer 304. The binding layer 304 links the void cells together while allowing the void cells to deform independently of one another, at least to an extent. In the linked system 300, the void cells in the top array 310 align with the void cells in the bottom array 312, with each void cell in the top array 310 opening away from a corresponding opposing void cell in the bottom array 312. In other implementations, each void cell in the top array 310 opens toward a corresponding opposing void cell in the bottom array 312. In still other implementations, the void cells in the top array 310 are not aligned with the void cells in the bottom array 312. In yet other implementations, the void cells in the top array 310 are a substantially different size and/or shape than the void cells in the bottom array 312.

In FIG. 3, the void cells have a square opening with a trapezoidal volume and a rounded peak. In other implementations, the void cells may have other shaped openings, volumes, and peaks (e.g., a round opening, with a cylindrical-shaped volume and a square peak). Each void cell in the linked system 300 is surrounded by neighboring void cells. For example, void cell 302 is surrounded by three neighboring void cells 303 within the top array 310. In the linked system 300, there are three neighboring void cells for each corner void cell, five neighboring void cells for each edge cell, and eight neighboring void cells for the rest of the void cells. Other implementations may have greater or fewer neighboring void cells for each void cell. Further, each void cell may have a corresponding opposing void cell within an opposite array. For example, void cell 302 in the top array 310 is opposed by void cell 314 in the bottom array 312. Other implementations do not include opposing void cells for some or all of the void cells. Still further, each void cell can have neighbor cells that have opposing cells in an opposite array. For example, void cell 302 in the top array 310 has a neighbor 303, and on opposing cell 316 in the bottom array 312.

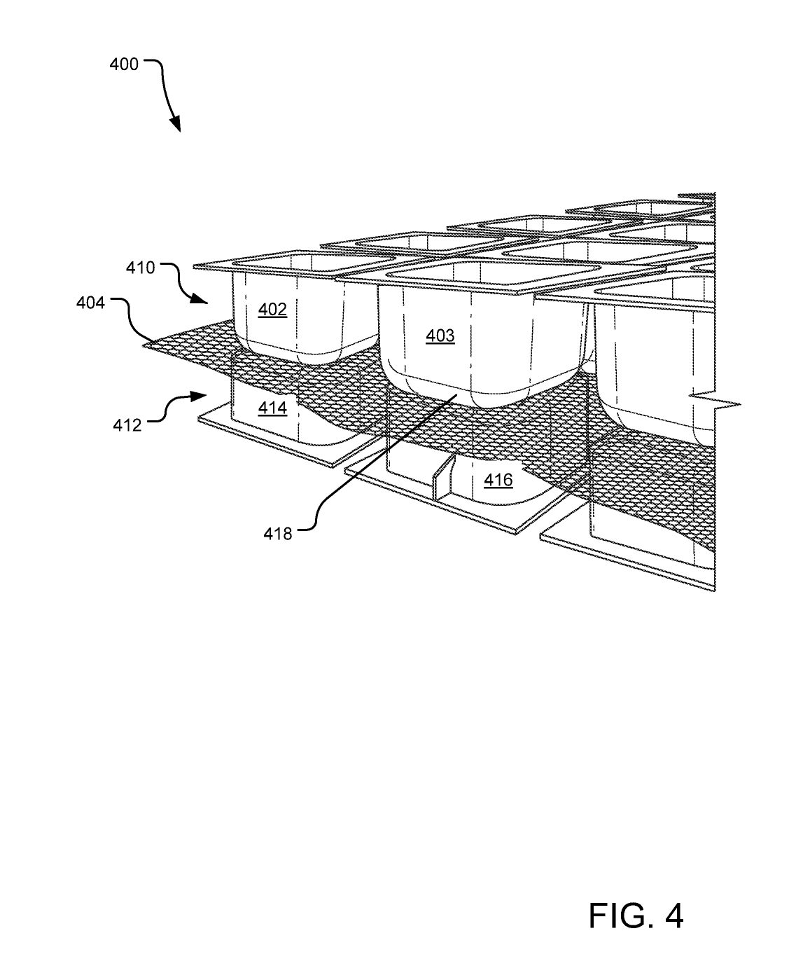

FIG. 4 illustrates a side perspective view of an example linked system 400 of individual opposing void cells (e.g., void cells 414). The void cells in the linked system 400 are arranged in a top array 410 and a bottom array 412. Each array includes an array of void cells linked together using a common separate binding layer 404, which is attached to a peak (e.g., peak 418) of each of the void cells. In the implementation of FIG. 4, the void cells have a square opening with a trapezoidal volume and a rounded peak. In other implementations, the void cells may have other shaped openings, volumes, and peaks (e.g., a round opening, with a cylindrical-shaped volume and a square peak).

Each void cell in the linked system 400 is surrounded by neighboring void cells. For example, void cell 402 is surrounded by neighboring void cells (e.g., void cell 403) within the top array 410. Further, each void cell can have a corresponding opposing void cell within an opposite array. For example, void cell 402 in the top array 410 has a corresponding opposing void cell 414. Still further, each void cell can have neighbor cells that have opposing cells in an opposite array. For example, void cell 402 in the top array 410 has a neighboring void cell 403, which has a corresponding neighbor opposing cell 416 in the bottom array 412.

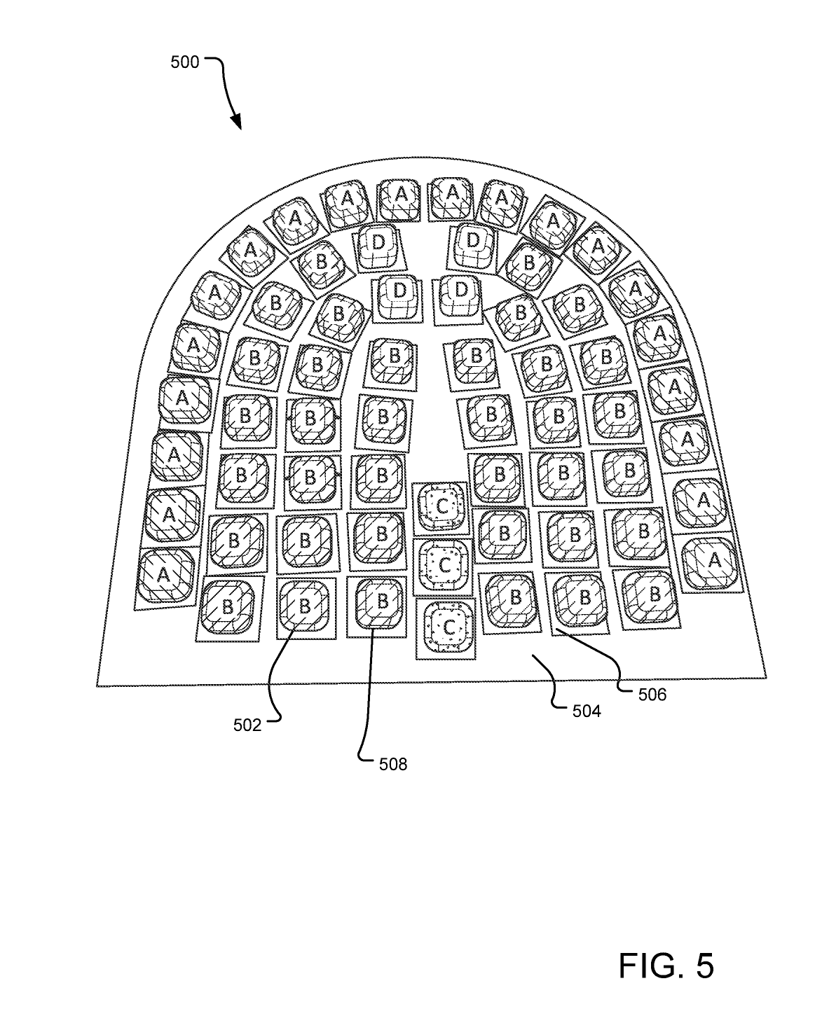

FIG. 5 illustrates a bottom plan view of an example linked array 500 of individual void cells (e.g., void cell 502) having varying force-deflection characteristics. The linked array 500 is a spaced array of individually formed void cells linked together using a separate binding layer 504, which is attached to a flange (e.g., flange 506) of each of the void cells. In FIG. 5, the individual void cells have a square opening with a trapezoidal volume and a rounded top. In other implementations, the void cells may have other shaped openings, volumes, and peaks (e.g., a round opening, with a cylindrical-shaped volume and a square top).

Choice of void cell material, geometry, and/or wall thickness determines the force-deflection characteristics of each void cell. In order to customize the linked array 500 for a particular application where a varied load distribution is expected to be applied to the linked array 500 (e.g., on a seat or mattress), sub-arrays of void cells or individual void cell themselves may be designed to apply different reaction forces. For example, if linked array 500 is used for a seating application, a peak load may occur beneath a user's sit bones or ischial tuberosity. As a result, void cells labeled “A” (e.g., 45 mil thickness) in FIG. 5 may be designed to deflect under lower force (i.e., have a lower reaction force per unit of deflection) than other void cells in the linked array 500. As a result, a user's weight is more evenly distributed over the entire linked array 500. Void cells labeled “B” (e.g., 60 mil thickness) in FIG. 5 may be designed with a higher reaction force per unit of deflection, as the void cells “B” are positioned farther away from the user's sit bones. Void cells labeled “C” (e.g., 70 mil thickness) in FIG. 5 may be designed to an even higher reaction force per unit of deflection than void cells “A” and “B”, as void cells “C” are positioned even further away from the user's sit bones. In some implementations, the sub-arrays of void cells or individual void cell themselves are designed with stiffer cells on or near a perimeter of the linked array 500 in order to aid centering of a user sitting or lying on the linked array.

The binding layer 504 is a substantially planar layer used to link the individually formed void cells together. Each void cell is surrounded by a number of neighboring void cells within the linked array 500. For example, void cell 502 is surrounded by five neighboring void cells (e.g., void cells 508). In some implementations, multiple linked arrays may be stacked on top of one another (e.g., two or more linked arrays 500 stacked on top of one another) to achieve intended compression/rebound characteristics of an overall system.

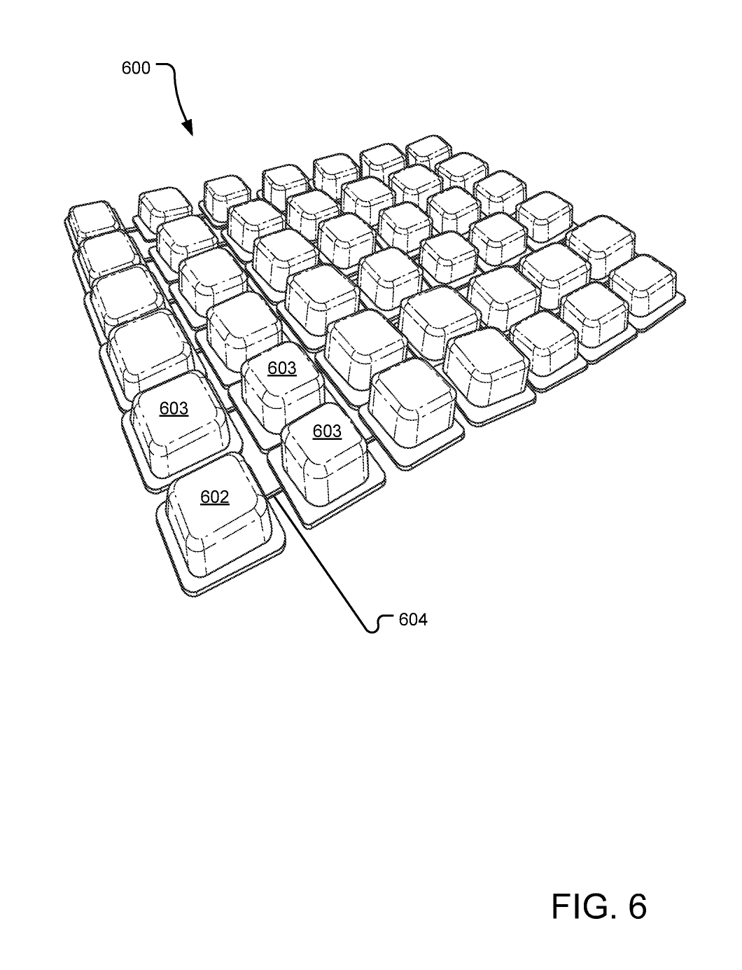

FIG. 6 illustrates a bottom perspective view of an example linked array 600 of individual void cells (e.g., void cell 602). The linked array 600 is a spaced array of void cells linked together using a binding layer, wherein the binding layer comprises binding strips (e.g., binding strips 604). The binding strips 604 link the void cells and allow the linked array 600 to readily conform to a variety of surface contours (e.g., a flat surface, a concave surface, a convex surface, and/or a surface with multiple contours). In some implementations, the binding strips are constructed with the same potential materials as the void cells (listed above) and are formed integrally with the void cells. In other implementations, the binding strips are attached to the void cell flanges or supplemental flanges via permanent and/or removable connections (e.g., a glued connection, a melted connection, a UV-cured connection, a RF welded connection, a laser-welded connection, another welded connection, a sewn connection, and a hook-and-loop connection). The binding strips and the void cell flanges or supplemental flanges may be pressed together to assist the attachment of the binding strips to the void cell flanges. The binding strips may have the same or a different thickness than the void cell wall thickness (e.g., 1 mil-1000 mil).

In FIG. 6, the void cells have a square flanged opening with a trapezoidal volume and a rounded top. In other implementations, the void cells may have other shaped flanged openings, volumes, and tops (e.g., round flanged opening, with a cylindrical-shaped volume and a square top.).

Each void cell is surrounded by a number of neighboring void cells within the linked array 600. For example, void cell 602 is surrounded by three neighboring void cells (e.g., void cells 603). In other implementations, multiple linked arrays may be stacked on top of one another (e.g., two or more linked arrays 600 stacked on top of one another) to achieve intended compression/rebound characteristics of an overall system.

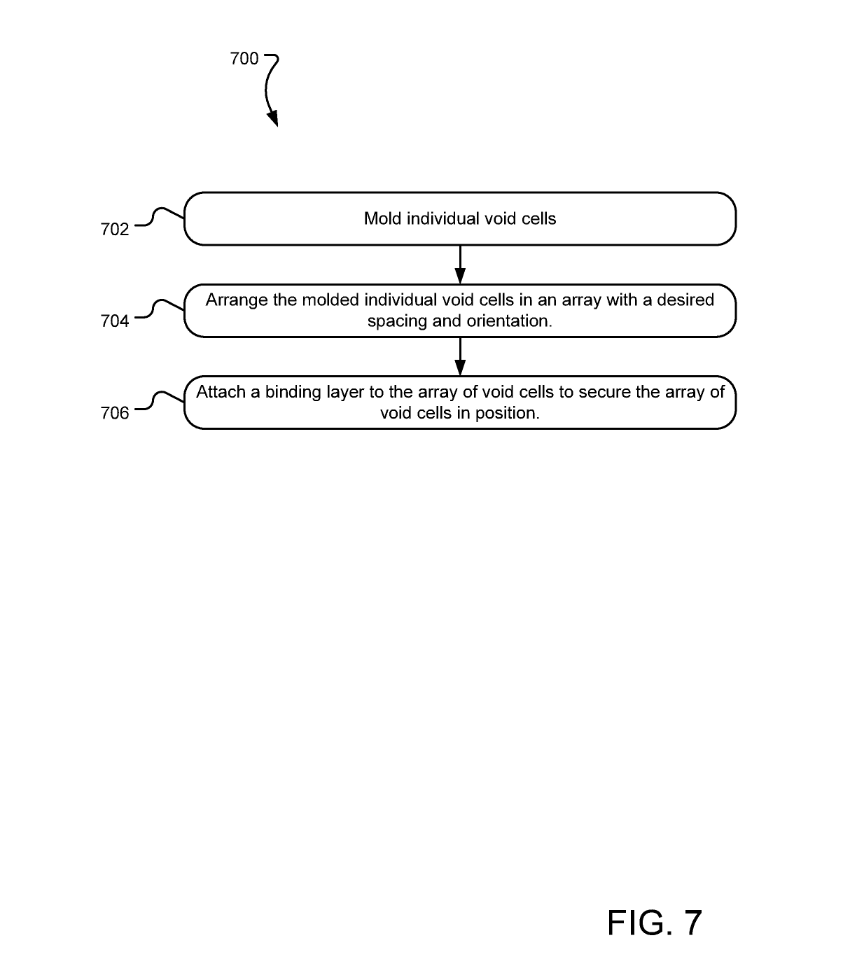

FIG. 7 illustrates example operations 700 for manufacturing a linked array of void cells. A molding operation 702 molds individual void cells and/or sub-arrays of void cells from bulk material. In one implementation, a common void cell geometry is achieved by reusing a mold or set of molds to produce the individual void cells. In other implementations, sub-arrays of void cells with common void cell geometry are produced using the molding operation 702. For example, each void cell within a sub-array has common force-deflection characteristics. The molding operation 702 molds sufficient individual void cells and/or sub-arrays of void cells to produce one or more arrays of void cells.

An arranging operation 704 arranges the molded individual void cells and/or sub-arrays of void cells in an array with a desired spacing and orientation. In one implementation, the individual void cells or subarrays of void cells are flipped to face a common direction (e.g., facing upwards or facing downwards), turned to a common rotational direction (e.g., sides of each individual void cell are arranged parallel to one another), and/or given a desired spacing (e.g., a fixed spacing between the individual void cells or a preselected variable spacing between the individual void cells). In some implementations, a tray with cutouts corresponding to the desired spacing and orientation of the individual void cells or subarrays of void cells is used to achieve the desired spacing and orientation of the individual void cells. In other implementations, pick-and-place robotic technology may be used to automate the arranging operation 704.

An attaching operation 706 attaches a binding layer to the array of void cells to secure the array of void cells in a desired position. The binding layer may take several forms (e.g., a solid planar layer, a perforated planar layer, a mesh layer, and/or individual binding strips). The attaching operation 706 is accomplished by gluing, melting, UV-curing, RF welding, laser-welding, and/or sewing, for example, and may include pressure applied between the array of void cells and the binding layer to assist the attachment of the binding layer to the void cells. In some implementations, the binding layer may be attached to a flange associated with an opening in each of the void cells, a supplemental flange, or at a closed peak of each of the void cells. In implementations where the binding layer is attached to sub-arrays of void cells, the binding layer may not be attached to each individual void cell, but a selection of individual void cells within the sub-array.

The logical operations making up the embodiments of the invention described herein are referred to variously as operations, steps, objects, or modules. Furthermore, it should be understood that logical operations may be performed in any order, adding or omitting operations as desired, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method of manufacturing an array of void cells, the method comprising:
molding individual void cells;
arranging the individual void cells in an array; and
attaching a separate binding layer to the individual void cells in the array.

2. The method of claim 1, wherein the individual void cells are molded by one of a thermoforming, extrusion, laminating, blow molding, or injection molding process.

3. The method of claim 1, wherein the separate binding layer is attached to the individual void cells using one or more of gluing, welding, or stitching.

4. The method of claim 1, wherein the individual void cells are arranged in a planar array.

5. The method of claim 1, wherein the individual void cells are not in contact with each other following the arranging operation.

6. The method of claim 1, wherein the separate binding layer is attached to the individual void cells via flanges located on the individual void cells.

7. The method of claim 1, wherein the separate binding layer is attached to the peaks of the individual void cells via supplemental flanges located on the flanges of the individual void cells.

8. The method of claim 6, wherein the separate binding layer is attached to the individual void cells via permanent connectors.

9. An array of void cells comprising:
two or more individually formed void cells; and
a separate binding layer attached to the individually formed void cells.

10. The array of void cells of claim 9, wherein the binding layer links the individually formed void cells together while allowing fluid flow through the separate binding layer and the individually formed void cells.

11. The array of individually formed void cells of claim 9, wherein the individually formed void cells comprise of at least one of thermoplastic urethane, thermoplastic elatomers, styrenic co-polymers, and rubber.

12. The array of void cells of claim 9, wherein the separate binding layer attaches to supplemental flanges located on the flanges of the individually formed void cells.

13. The array of void cells of claim 9, wherein the individually formed void cells and the binding layer comprise of different materials.

14. The array of void cells of claim 9, wherein the binding layer attaches to flanges on the individually formed void cells via a removable connection.

15. The array of void cells of claim 9, wherein the separate binding layer attaches to flanges on the individually formed void cells via a permanent connection.

16. The array of void cells of claim 9, wherein the array of void cells is stackable.

17. The array of void cells of claim 9, wherein at least two of the individually formed void cells have substantially different force-deflection characteristics.

18. A resiliently compressible void cell system, comprising:
a first array of individually formed void cells;
a second array of individually formed void cells; and
a porous binding layer common to the first array and the second array.

19. The resiliently compressible array of void cells of claim 18, wherein the first array and the second array are aligned with each void cell opening away from a corresponding individually formed void cell.

20. The resiliently compressible array of void cells of claim 18, wherein the first array and the second array are aligned with each individually formed void cell opening toward a corresponding individually formed void cell.
